(19) United States
(12) Patent Application Publication
(10) Pub. No.: US 2011/0120297 A1
(43) Pub. Date: May 26, 2011

(54) Hydraulic Circuit

(76) Inventors: MARCUS BITTER, MANNHEIM (DE); MARTIN TRINLER, HOCKENHEIM (DE); NICOLAS HUBER, KRIEGSFELD (DE); HOLGER LÜÜS, KLETTGAU (DE); KARL KERN, KUSSABERG (DE); WOLFGANG TODT, KLETTGAU (DE)

(21) Appl. No.: 12/784,116

(22) Filed: May 20, 2010

(30) Foreign Application Priority Data
Jul. 22, 2009 (DE) 10 2009 027 935.0

(51) Int. Cl. F15B 13/042

(52) U.S. Cl. 91/468

(57) ABSTRACT

A hydraulic circuit includes a control valve connected to a pump, a hydraulic reservoir, hydraulic work connections and a cylinder. A controllable check valve is connected between the work connections and the control valve. An overpressure safety device is connected between each work connection the corresponding check valve. In order to prevent sagging of a load on the cylinder, the overpressure safety device discharges hydraulic fluid between the check valve and the work connection to reduce an overpressure. The overpressure safety device includes an overpressure valve and a throttle connected downstream of this valve to throttle the flow of hydraulic fluid discharged through the overpressure safety device.

### FIELD OF THE INVENTION

The invention relates to a hydraulic circuit with a control valve, a hydraulic pump and a reservoir, for operating a hydraulic function.

### BACKGROUND OF THE INVENTION

Mobile work machines, for example, agricultural machines, such as tractors or harvesting machines, but also construction and forestry machines, are provided with hydraulic circuits for operating various hydraulic functions such as a hydraulic cylinder. Such hydraulic circuits include a function which holds the cylinder in its last. This holding function is important, among other things, so that work devices installed or attached to the mobile work machine cannot move the cylinder and cannot open flaps for holding back bulk goods or cannot lower components onto the ground during travel.

Such an adjustment of the cylinder can be caused by leaks at the control valves, in that small quantities of hydraulic fluid flow out via the valve slide of these control valves to the hydraulic tank. In order to avoid such an outflow of hydraulic fluid, leakproof non-return or check valves are inserted between the control valves and the work connections of the cylinders, wherein these check valves can be controlled as needed for the operation of the cylinder, in order to further guarantee the function of the control valves. Only in a neutral position of the control valves, that is, if no hydraulic fluid is to flow, do these check valves close without leaks. Different methods to construct such check valves are known in the state of the art and shall not be explained in detail here.

The work connections are often provided with so-called quick-connect couplers with which cylinders can be connected if needed. The quick-connect couplers close the work connection in a leakproof way relative to the surroundings when no cylinder is connected.

The leakproof check valve located between the work connection and the control valve prevents leakage at the control valve, while the quick-connect coupler at the work connection prevents leakage at the work connection. In a line section lying between the check valve and the quick-connect coupler, hydraulic fluid can be blocked accordingly, which heats up the fluid due to heating of a surrounding metal sleeve. This can be realized, for example, by solar irradiation or also by heating of the hydraulic fluid during operation. The result is an expansion of the hydraulic fluid volume. However, because the hydraulic fluid volume is blocked in a leakproof way and cannot expand, the pressure in the relevant line section increases. According to the physical properties of the hydraulic fluid, the seals, the structural construction of the line section, the pressure increase can also lead to failure of the relevant components.

In order to prevent pressure increases caused by heat, it is known to use overpressure safety devices, such as overpressure valves that are connected in the corresponding affected line sections. Such overpressure valves, or also called thermal-relief valves, are typically controlled by pressure and connected via an outflow line to the hydraulic tank, so that an adjustable pressure causes an opening of these valves in the affected line sections, whereupon the hydraulic fluid blocked in the line sections is discharged or released via the outflow line to the hydraulic tank. This leads to a pressure drop in the affected line section, whereupon the overpressure valve closes again as soon as the pressure falls below the adjustable limit pressure.

Such overpressure safety valves can also present problems, however, when used in mobile work machines. If the overpressure valve has, for example, too low a limit pressure, this can result in a sagging of the load in the case of the hydraulic cylinder connected to the work connection, when the overpressure valve is temporarily opened due to work-environment-generated pressure spikes and pressure in the work connection charged with the hydraulic cylinder or the line section connected to this work connection is abruptly released into the hydraulic tank. This means that a hydraulic cylinder would be moved increasingly inward for each occurrence of a pressure spike or each pressure jolt. This is not reasonable for the operator of the mobile work machine, who would like to know that, as a rule, a hydraulic cylinder moved by him is also fixed in its moved position.

If, however, the overpressure valve is set too high, in order to prevent sagging of the loads, the problem can occur that a quick-connect coupler that is preferably used on tractors must be designed for or made to withstand this high pressure, because correspondingly high pressure generated by heat is to be expected with a certain regularity. The pressure or overpressure generated by heat can assume values between 300 and 600 bar, but in contrast, the maximum system pressure of a tractor lies at merely 200 bar. An adaptation of the quick-connect couplers to the overpressures to be expected or an improvement in their durability is necessarily connected to high structural expense and could also bring additional disadvantages with it.

### SUMMARY

Accordingly, an object of this invention is to provide a hydraulic circuit which overcomes the problems described above.

This and other objects are achieved by the present invention, wherein a hydraulic circuit includes at least one overpressure safety device so that, by discharging hydraulic fluid between the check valve and a work connection, an established overpressure can be reduced. The overpressure safety device is an overpressure valve. Advantageously, the volume flow is throttled only after the overpressure valve, wherein, in the same way, throttling before the overpressure valve with the same effect and equivalent function is also conceivable.

The throttling is constructed such that the discharged hydraulic fluid can flow out only in very small quantities, advantageously drop by drop, from an overpressure-charged line section between the check valve and the work connection or is discharged into the hydraulic tank. The overpressure safety device comprises a pressure-controlled overpressure valve that opens when an adjustable limit pressure value is reached and that releases pressure from the affected line section in which it is until the pressure has fallen below the limit pressure value again. The overpressure valve can here be controlled by means of a control pressure line. A sensor-controlled electronic control is also conceivable, however. Thus, when a given or adjustable limit pressure value in the overpressure safety device is exceeded, a controlled leak is generated through which the excess pressure is slowly reduced in the affected line section between the check valve and work connection. In particular, it is avoided that the hydraulic fluid can flow out unimpaired or is discharged into the hydraulic tank, and thus abrupt volume flow changes due to pressure spikes in the hydraulic circuit that could cause sagging of the load on a hydraulic cylinder connected at the work connection are not to be expected. Simultaneously it is possible to design a quick-connect coupler arranged on the work connection for a system pressure that is typical for a tractor, so that preventative overdimensioning of the quick-connect coupler is not required for preventing damage, because the overpressure safety device can be designed for a limit pressure value commensurate to the system pressure.

The means for throttling the discharged hydraulic fluid or for throttling the volume flow can include a discharge channel through which the hydraulic fluid discharged through the at least one overpressure safety device is fed back to the control valve, wherein the throttling of the volume flow of the discharged hydraulic fluid is realized through the control valve affected by leaks caused by the technology being used. As already mentioned above, proportional control valves or control valves usually feature leaks caused by the technology being used. This can be used here to generate throttling of the hydraulic fluid discharged by the overpressure, in that the discharge channel leads the hydraulic fluid to the control valve and, indeed, into a line or hydraulic connection lying between the check valve and control valve. The overpressure can then be reduced through drop-by-drop discharge of the hydraulic fluid by means of the leaks of the control valve.

However, it is also conceivable that the means for throttling include a discharge channel through which the hydraulic fluid discharged through the at least one overpressure safety device can be discharged to the hydraulic tank and the discharge channel includes a device throttling the volume flow of the hydraulic fluid to the hydraulic tank. This device can be, for example, a conventional adjustable or also controllable choke or aperture or any other device reducing the volume flow in a hydraulic line.

The overpressure safety device and the at least one check valve can be constructed in a single integral hydraulic component or in a single integral component housing. This advantageously increases the compactness of the hydraulic circuit. The overpressure valves and also discharge channels can then be housed together with the check valve in a component housing.

The hydraulic circuit can include a so-called quick-connect coupler on a work connection or can be connected to such a coupler with which a cylinder can be connected to the hydraulic circuit. The work connection can be a quick-connect coupler, or lines still to be connected can be connected between a work connection and a quick-connect coupler. Obviously, the hydraulic circuit can have available multiple work connections and a corresponding number of quick-connect couplers. The quick-connect couplers allow a quick connection between the cylinder and the hydraulic circuit and hold the work connection closed as soon as the load is removed or disconnected.

The check valve blocking a return flow of hydraulic fluid without leaks is advantageously formed as a check valve and can be controlled in a pressure-controlled way by means of a control pressure line. The control can also be realized here, however, electronically or in a different way. The valve device can also be constructed differently in the form of a check valve. In particular, it is possible to arrange pressure-controlled switching valves that switch from a closed position into an open position through corresponding control pressure lines, wherein, in the closed position, a leakproof blockage of the fed-back hydraulic fluid is given. Here it is also conceivable to control the switching valves not in a pressure-controlled way but instead electrically or electromagnetically. In connection with the present constructions, the return flow of hydraulic fluid is understood as a hydraulic fluid flow coming from the cylinder, for example, flowing out from the chamber of a hydraulic cylinder to the hydraulic tank. In principle, it should be guaranteed that leakage of hydraulic fluid at the control valve is prevented in that there is a leakproof valve device that is permeable for hydraulic fluid in the direction of the cylinder and that blocks a return flow without leaks. Furthermore, however, it should also be guaranteed that this valve device is controllable, that is, can be opened if, as a function of the operation, a return flow of hydraulic fluid that is guided from the cylinder to the hydraulic tank is required. This is the case when, for example, one chamber of a hydraulic cylinder is filled and the other chamber is emptied. Accordingly, the valve device that is connected on the side of the chamber to be emptied must then be controlled, but the valve device that is connected on the side of the chamber to be filled is closed in the direction of the control valve and blocks a return flow without leaks.

In a special embodiment, the hydraulic circuit includes two work connections for a cylinder, wherein a leakproof check valve blocking a return flow of hydraulic fluid is r between the work connections and the control valve. An overpressure safety device is further provided between a work connection and the corresponding check valve blocking a return flow of hydraulic fluid without leaks. The corresponding overpressure device is connected and constructed such that, through discharge of hydraulic fluid between the corresponding check valve and the corresponding work connection, an established overpressure can be reduced. The corresponding overpressure safety device includes an overpressure valve and means connected hydraulically downstream of this valve, wherein these means can generate, according to the above constructions, a throttling of the volume flow of the hydraulic fluid discharged by the corresponding overpressure safety device.

The valve devices blocking a return flow of hydraulic fluid without leaks are advantageously constructed as check valves and connected to the control valve by means of a hydraulic line. Furthermore, the line of one check valve is connected via a control pressure line to the other check valve and the line of the other check valve is connected via a control pressure line to the other check valve, wherein, by means of the control pressure lines, the corresponding valve devices or check valves can be controlled hydraulically. For example, a control pressure line connected to the lowering side of a cylinder opens the check valve connected on the lifting side. The check valve connected on the lowering side is open hydraulically in a corresponding way by a control pressure line that is connected to the lifting side of the cylinder. This type of hydraulic cross mounting of control pressure lines between two check valves connected on different lines (hydraulic supply lines) can also be constructed differently according to the construction of the valve devices blocking the return flow of hydraulic fluid without leaks, as long as, when one line (hydraulic supply line) is pressurized, a control (opening) of the valve device blocking the return flow of the hydraulic fluid without leaks is initiated in the other line (hydraulic supply line). Here it is also conceivable to realize the control of the leakproof check valves electronically, mechanically, electromechanically, electrohydraulically, electromagnetically, hydromechanically, or in other ways. The hydraulic circuit described above is suitable both for two-sided and also one-sided hydraulic cylinders. For the latter case, only one work connection is provided that is accordingly connected to a valve device blocking the return flow of hydraulic fluid without leaks, for example, a leakproof check valve. The control of the check valve can then be performed, for example, by means of a control pressure line that can be connected to the hydraulic pump. If the chamber of the one-sided hydraulic cylinder is connected to the tank, for example, because the hydraulic cylinder is to be lowered and the chamber must be emptied, the check valve is hydraulically opened simultaneously by the control pressure line connected to the hydraulic pump. The connection to the control pressure line is interrupted as soon as the chamber of the hydraulic cylinder is refilled or closed (hydraulic cylinder is held in its position). Alternatively, here the opening of the check valve can also be performed electronically, mechanically, electromechanically, electrohydraulically, electromagnetically, hydromechanically, or also in other ways. Furthermore, a different type of valve device blocking the return flow of hydraulic fluid without leaks can also be selected that optionally also has one or more control pressure lines connected differently.

According to the above constructions, a hydraulic circuit is created that guarantees protection against heat-generated overpressures, without causing sagging of loads in the case of pressure spikes and without overdimensioning of the quick-connect coupler having to be realized with respect to system pressure and construction, in order to guarantee their fatigue strength for high thermal pressures. It is guaranteed that, in the case of pressure spikes, the corresponding overpressure valve opens, but this has no negative effect with respect to sagging of an application, because the oil can flow out only drop by drop behind the overpressure valves. However, if a heat-generated pressure is slowly building up, the overpressure valve would open starting at a certain, adjustable pressure value (limit pressure value) and the leakage that can flow out, for example, via the valve slide of a control valve, would prevent further pressure buildup. The pressure that can be set at an overpressure valve of an overpressure safety device can be set to a value slightly above the maximum system pressure of the hydraulic circuit, in order to guarantee that loads raised with the maximum pressure cannot be slowly lowered again. In this way, because this pressure setting lies only barely above the maximum pressure of the hydraulic circuit, the risk of a permanent overload of the quick-connect coupler is also avoided and the quick-connect coupler does not have to be adapted to higher pressures. As already mentioned, the hydraulic circuit can be advantageously constructed in a compact way, in that the overpressure valves or the overpressure safety device is integrated into the valve devices (for example, check valves) that can be blocked or controlled and that block the return flow of hydraulic fluid without leaks, so that no changes or only small changes must be performed on the housings of the control valve. Thus, the advantages of a hydraulic circuit according to the invention can be seen especially in that protection from thermal overpressures is created with respect to quick-connect couplers and control valves with leakproof check valves, no or only minimal adaptation of quick-connect couplers or other components installed on the control valves to heat-generated overpressures is required, sagging of loads due to pressure spikes is prevented, and, in the case of integration of the overpressure valves in the leakproof check valves, no complicated housing adaptation to the control valves is required. The latter further allows the creation of a modular control valve setup concept in which the corresponding parts of the overpressure safety device can be integrated or also retrofitted into an existing hydraulic circuit in connection with valve devices or leakproof check valves blocking the return flow of hydraulic fluid without leaks.

### BRIEF DESCRIPTION OF THE DRAWINGS

FIG. 1 is a simplified side view of an agricultural vehicle with a hydraulic circuit according to the invention;

FIG. 2 is a schematic diagram of a hydraulic circuit according to the invention;

FIG. 3 is a schematic diagram of an additional embodiment of a hydraulic circuit according to the invention; and

FIG. 4 is a schematic diagram of an additional embodiment of a hydraulic circuit according to the invention.

### DESCRIPTION OF THE PREFERRED EMBODIMENT

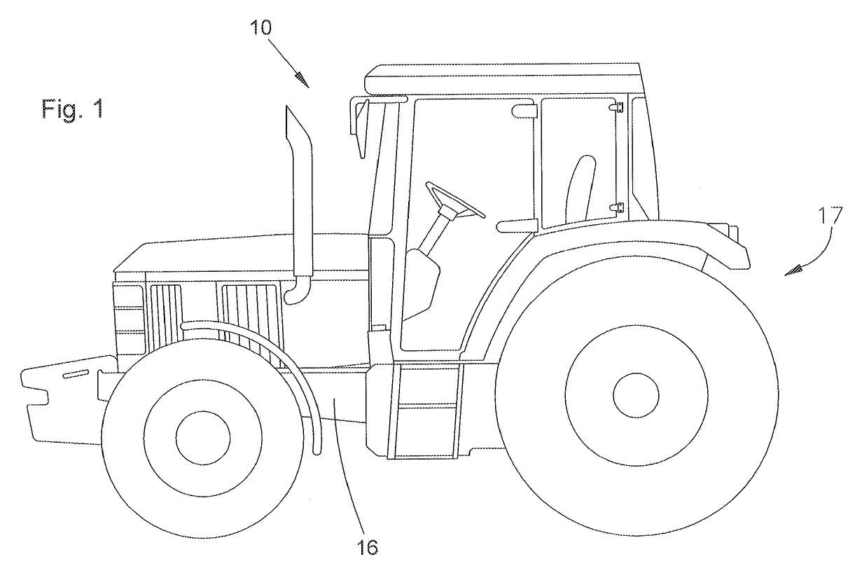

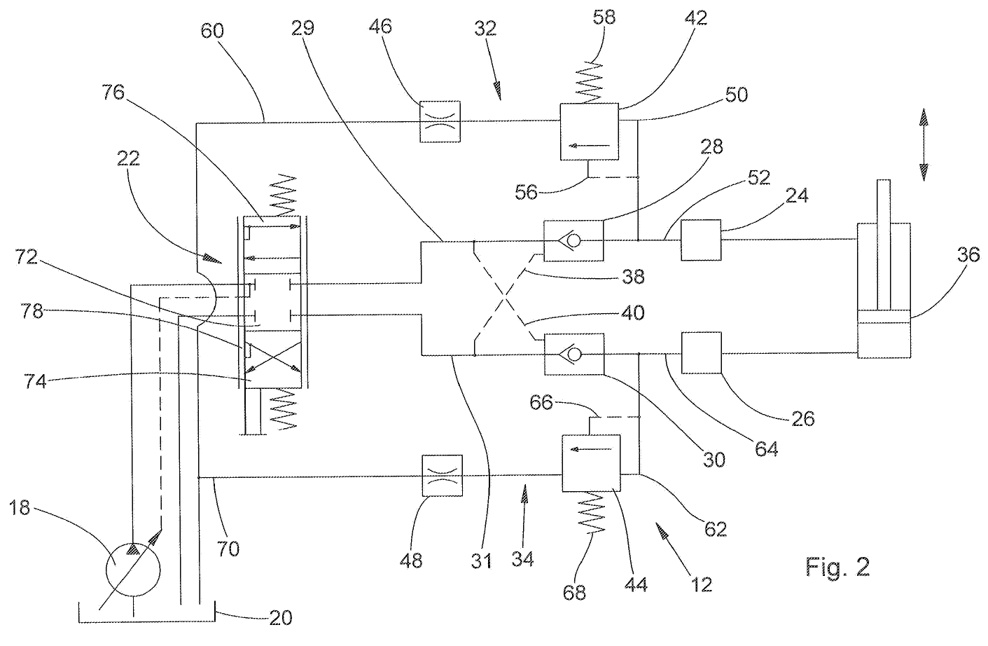

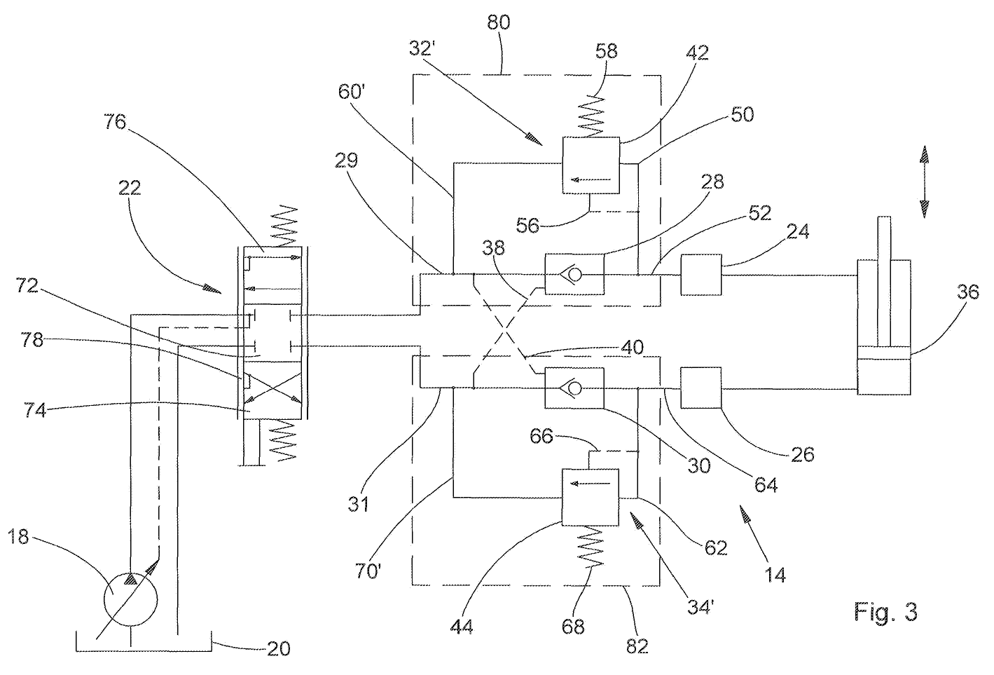

FIG. 1 shows an agricultural vehicle 10 in the form of a tractor or hauler that includes the hydraulic circuit 12, 14 shown in FIGS. 2 and 3. The hydraulic circuits shown schematically in FIGS. 2 and 3 are described only as examples in connection with the tractor and can also be used in the same way in other agricultural vehicles, such as harvesting machines, crop-protection machines, planting and sowing machines, but also in construction and forestry machines.

The vehicle 10 includes a frame 16 on which is arranged, at a rear region 17, a three-point coupling device or hitch (not shown) for operating attachment or work devices (not shown). The hitch can be arranged in the same way also at a front region of the vehicle 10. The hitch includes a hydraulic circuit 12, 14, 15 according to FIGS. 2, 3 and 4. The hydraulic circuits 12, 14, 15 can also be used, furthermore, in connection with other hydraulically operated devices on the vehicle 10, such as, for example, a front loader or a work device pulled by means of a tow bar.

According to FIG. 2, the hydraulic circuit 12 includes a hydraulic source or variable pump 18, a hydraulic reservoir or tank 20, a hydraulic control valve 22 for controlling the hydraulic flow, a first and second work connection 24, 26 for connecting to a hydraulic function or cylinder 36, a first and second valve device 28, 30, such as a check valve which prevent fluid flow back to the control valve 22, a first and second overpressure safety device 32, 34, as well as a hydraulic cylinder 36.

The check valve 28 is connected between the work connection 24 and the control valve 22, wherein a hydraulic line 29 connects the control valve 22 and the check valve 28 to each other. The check valve 30 is connected between the work connection 26 and the control valve 22, wherein a hydraulic line 31 connects the control valve 22 and the check valve 30 to each other. The check valves 28, 30 can be controlled by means of control pressure lines 38, 40. The check valve 28 connected on line 29 or allocated to the work connection 24 is connected to the control pressure line 38 that is connected, in turn, to the line 31. By pressurizing the line 31 and thus the control pressure line 38, a control (opening) of the check valve 28 can be performed. Analogously, the check valve 30 connected on the line 31 or allocated to the work connection 26 is connected to the control pressure line 40 that is connected, in turn, to the line 29. By pressurizing the line 29 and thus the control pressure line 40, a control (opening) of the check valve 30 can be performed.

The work connections 24, 26 are preferably quick-connect couplers to which the cylinder 36 can be connected. The work connections 24, 26 each include a check valve (not shown) that closes in the direction of the cylinder 36 without leaks and that is closed as soon as a connection of the work connections 24, 26 to the cylinder 36 is interrupted or the cylinder 36 is separated from the work connections.

The overpressure safety devices 32, 34 each include an overpressure valve 42, 44 and a device 46, 48 throttling the volume flow and constructed as a choke. The device 46, 48 throttling the volume flow can here also be constructed as an aperture or also as another hydraulic device throttling the volume flow.

The overpressure safety device 32 is connected between the check valve 28 and the work connection 24, wherein a hydraulic line 50 branches from a hydraulic line 52 connecting the check valve 28 and the work connection 24 and connects this to the overpressure valve 42. A control pressure line 56 connected to the line 50 leads to the overpressure valve 42 and allows the control (opening) when a limit pressure value that can be set by means of an adjustment spring 58 is exceeded in the line 50 or 52, wherein the adjustment spring 58 holds the overpressure valve 42 in a closed position as long as the limit pressure value has not been reached. On the outflow side of the overpressure valve 42, a discharge channel 60 connects in the form of a hydraulic line connected to the hydraulic tank 20, wherein the discharge channel 60 is equipped with the device 46 throttling the volume flow or includes this device, so that the volume flow of a hydraulic fluid flowing through the discharge channel 60 is throttled and this can flow out only slowly or throttled to the hydraulic tank 20. The device 46 throttling the volume flow can here also be connected in front of the overpressure valve 42, because it is used primarily only for reducing the volume flow. This function or effect was also achieved through the arrangement in front of the overpressure valve.

The overpressure safety device 34 is constructed in an analogous way. The overpressure safety device 34 is connected between the check valve 30 and the work connection 26, wherein a hydraulic line 62 branches from a hydraulic line 64 connecting the check valve 30 and the work connection 26 and connects this to the overpressure valve 44. A control pressure line 66 connected to the line 62 leads to the overpressure valve 44 and allows the control (opening) when a limit pressure value that can be set by means of an adjustment spring 68 is exceeded in the line 62 or 64, wherein the adjustment spring 68 holds the overpressure valve 44 in a closed position as long as the limit pressure value has not been reached. On the outflow side of the overpressure valve 44, a discharge channel 70 connects in the form of a hydraulic line connected to the hydraulic tank 20, wherein the discharge channel 60 is equipped with the device 48 throttling the volume flow or includes this device, so that the volume flow of a hydraulic fluid flowing through the discharge channel 70 is throttled and this can flow away only slowly or throttled to the hydraulic tank 20. Here, in an analogous way, the device 48 throttling the volume flow can also be connected in front of the overpressure valve 44.

The flowing out of the hydraulic fluid is preferably performed advantageously only drop by drop, so that only very small quantities can flow out through which, indeed, an overpressure in the lines 50, 52, 62, 64 can be reduced, but, on the other hand, no sagging of a load held or carried by the loaded device 36 is to be expected.

The control valve 22 is advantageously constructed, but merely as an example, as a proportional control valve and has available no-step, controllable control positions that can be controlled both mechanically, in particular, manually, or also electronically or in another way. The control positions include a neutral position 72 in which all of the inputs and outputs of the control valve 22 are closed, a lifting position 74 in which the line 31 is connected to the hydraulic pump 18 and the line 29 is connected to the hydraulic tank 20, as well as a lowering position 76 in which the line 29 is connected to the hydraulic pump 18 and the line 31 is connected to the hydraulic tank 20. The control valve 22 is affected by (natural) leakage that is caused by the technology being used and that has the result that a (prevailing) hydraulic pressure built up in a line 29, 31 connected to the control valve 22 is reduced by the proportional valve slide 78, in that the hydraulic fluid flows out in small quantities via the proportional valve slide to the hydraulic tank 20 (leakage caused by the technology being used). In order to counteract the effect of such leakage caused by the technology being used, the use of leakproof check valves 28, 30, like those connected between the lines 29, 52 and 31, 64, are provided or required.

The hydraulic circuit 12 functions as follows. If the vehicle 10 is operated with a connected cylinder 36, then the cylinder 36 connected via the quick-connect coupler to the work connections 24, 26 can be operated or held by means of the control valve 22 according to a controlled position of the proportional valve slide 78 in a lifting position 74, lowering position 76, or also a neutral position 72, wherein, in the lift position 74, the leakproof check valve 28 can be opened or controlled by means of the control pressure line 38 and in the lowering position 76, the leakproof check valve 30 is opened or controlled by means of the control pressure line 40. Now, in one of the positions 72, 74, 76, if a load now lies on the cylinder, the exceeding of the limit pressure value set in one of the two overpressure valve 42, 44 due to pressure spikes leads to the control (opening) of the corresponding overpressure valve 42, 44 through the control pressure lines 56, 66. Pressure spikes can be caused by mass movements due to unevenness on the field or on the road surface or due to other resistances acting on the work device or the cylinder 36 (temporarily). Through the means provided in the overpressure safety devices 32, 34 for throttling the volume flow in the form of devices 46, 48 throttling the volume flow and connected on the outflow side in the discharge channel, the hydraulic fluid cannot flow, however, unimpaired to the hydraulic tank 20, so that a pressure buildup can be realized only very slowly, advantageously drop by drop. Therefore, sagging of the load on the cylinder 36 is avoided, because typically the mentioned pressure spikes are maintained only very shortly and the overpressure valve 42, 44 is closed again, before an essential outflow of hydraulic fluid could be noticed.

If the vehicle 10 is to be operated without connected cylinder 36, then the leakproof check valves integrated in the quick-connect coupler on the work connections 24, 26 close the lines 52, 64 to the outside without leaks. Simultaneously, the check valves 28, 30 close the lines 52, 64 in the direction of the control valve 22 without leaks. Now if a temperature-generated pressure increase is produced in one or both of the lines 52, 64, the pressure is increased until the limit pressure value of one of the overpressure valves 42, 44 is reached and this opens accordingly. Immediately, hydraulic fluid can flow out to the hydraulic tank 20 throttled by the corresponding means for throttling the volume flow or by the devices 46, 48 throttling the volume flow and the discharge channels (discharge lines) 60 or 70, so that the pressure in one or two lines 52, 64 can be slowly reduced again until this has again assumed a value below the limit pressure value set in the overpressure valves 42, 44. In this way, damage that can occur to the hydraulic circuit 12 due to temperature-generated pressure increases can be effectively prevented. Advantageously, the hydraulic circuit 12 is dimensioned such that a thermally caused pressure increase can be achieved only up to the height of the limit pressure value of the overpressure valves 42, 44, because, in addition, due to the hydraulic fluid flowing out being throttled, an additional pressure increase is counteracted or an additional pressure increase is essentially absent.

An additional embodiment of a hydraulic circuit 14 according to the invention is shown in FIG. 3. The hydraulic circuit 14 shown in FIG. 3 differs merely in the construction of overpressure safety devices 32′, 34′ that are provided for the individual work connection 24, 26 and that differ as follows relative to the overpressure safety devices 32, 34 shown in FIG. 2, wherein similar parts and components are named or provided with the same reference symbols as in the embodiment to FIG. 2. The overpressure safety devices 32′, 34′ likewise have lines 50, 62 to which connects an overpressure valve 42, 44, respectively. The overpressure valves 42, 44 are also adjustable here by corresponding adjustment springs 58, 68 and can be controlled by means of corresponding control pressure lines 56, 66. Each overpressure safety device 32′, 34′ likewise has available a discharge channel 60′ or 70′, wherein the discharge channels 60′, 70′ here, in contrast to the embodiment in FIG. 2, are not equipped with or do not include a device 46, 48 throttling the volume flow and do not lead into the hydraulic tank 20, but instead lead directly into the lines 29 or 31 connected to the control valve 22 and the check valves 28 or 30. Here, the means for throttling the volume flow of the hydraulic fluid discharged into the discharge channels 60′ or 70′ include no additional devices 46, 48 throttling the volume flow, but instead only the control valve 22 itself, which is used as means for throttling the volume flow, wherein the throttling is realized by means of the previously mentioned (natural) leakage of the control valve 22 caused by the technology being used or the proportional valve slide 78 contained therein. The effect and function of the hydraulic circuit 14 according to FIG. 3 is comparable with that of the hydraulic circuit 12 according to FIG. 2, according to which the statements described above also apply here: when cylinders 36 are connected, the occurrence of pressure spikes that cause a control (opening) of the overpressure valves 42, 44 does not lead to sagging of the load, because the outflowing hydraulic fluid is throttled or blocked by the control valve 22 itself from flowing out to the hydraulic tank 20 without resistance. When a cylinder 36 is not connected, it is similarly guaranteed that a temperature-generated pressure increase in one or both of the lines 52, 64 can be reduced again slowly, because small quantities of hydraulic fluid can flow out throttled via the control valve 22 to the hydraulic tank 20 due to the (natural) leakage of the control valve 22 caused by the technology being used. In this way, damage that can occur to the hydraulic circuit 14 due to temperature-generated pressure increases can also be effectively avoided. The effects are thus comparable with those from the previous embodiment according to FIG. 2. It is especially advantageous in the hydraulic circuit 14 according to FIG. 3, however, that the overpressure safety devices 32′, 34′ can each be constructed together with the corresponding leakproof check valves 28 or 30 as a combined, single, integrated hydraulic component 80 or 82, wherein it is further allowed to retrofit an existing hydraulic circuit without overpressure safety device 32, 34, 32′, 34′ in an especially simple way.

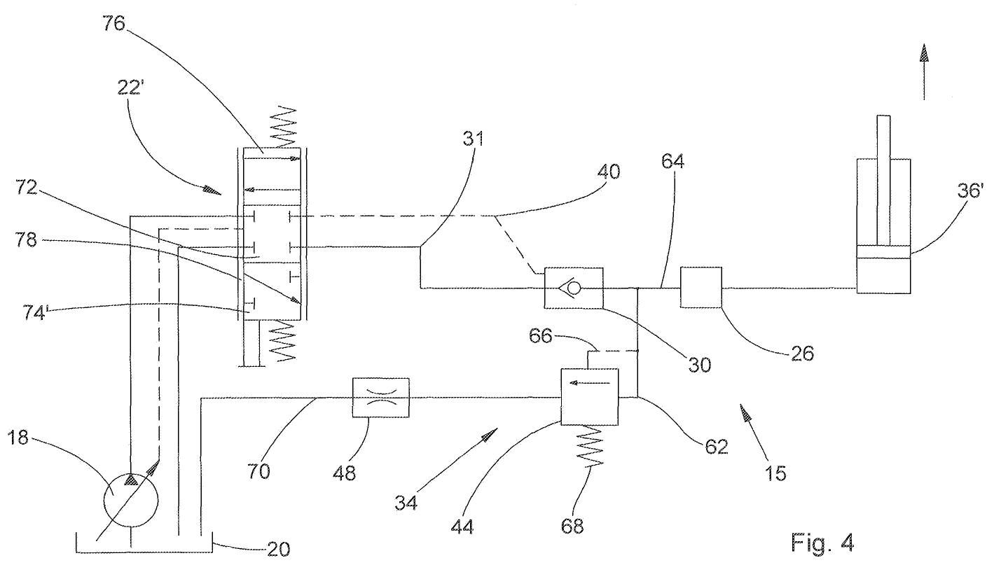

An additional embodiment of a hydraulic circuit 15 according to the invention is shown in FIG. 4. The hydraulic circuit 15 shown in FIG. 4 differs essentially from the preceding two embodiments of the hydraulic circuits 12, 14 in that the cylinder is constructed as a one-sided cylinder 36′ and thus only one work connection 26 is pressurized. Accordingly, the hydraulic circuit shown in FIG. 4 includes only the components in active hydraulic connection to the work connection 26. Because only one chamber of the cylinder 36′ can be pressurized, only one work connection 26 is also used that can be controlled by means of the control valve 22′. As an example, in the case of this embodiment, the lifting side of the cylinder 36′ was selected and, according to this selection, the work connection 26 and the components connected to this connection. Equivalently, however, the lowering side of the cylinder 36′ could also be selected and, according to this selection, the work connection 24 and the components connected to this connection. The overpressure safety device 34 is constructed, as an example, structurally identical to the embodiment of the hydraulic circuit 12 according to FIG. 2. However, it could also be structurally identical to the embodiment of the hydraulic circuit 14 according to FIG. 3, that is, the discharge line 70 can be constructed leading to the hydraulic tank 20 with devices 48 throttling a volume flow according to FIG. 2, or also as a discharge line 70′ leading directly into the line 31 according to FIG. 3, wherein here the construction of a combined, single integrated hydraulic component 82 (or 80) is possible. For the embodiment according to FIG. 2, in an analogous way it would also be conceivable to arrange the device 48 throttling the volume flow in front of the overpressure valve 44.

The essential difference, however, consists in that the control pressure line 40 is charged separately with pressure, in order to control (to open) the check valve 30, because no corresponding line 29 is provided. For this purpose, the control pressure line 40 is connected directly to the control valve 22′. With the switching position 76, as the lowering position for lowering the cylinder 36′, a connection is established between the pump 18 and the control pressure line 40, wherein the check valve 30 is controlled (opened) and the hydraulic fluid can flow out from the chamber of the cylinder 36′ through the line 31 into the hydraulic tank 20. Furthermore, the control valve 22′ includes, as a lifting position, in place of the switch position 74 from the preceding embodiments, a switch position 74′ in which only the line 31 is connected to the pump 18 and simultaneously the control pressure line 40 is interrupted or closed. The effect and function of the overpressure safety device 34 of the hydraulic circuit 15 corresponds incidentally to the two preceding embodiments according to FIGS. 2 and 3, whereupon reference can be made to the preceding statements with the difference already mentioned above that the cylinder 36′ connected here loads only a work connection 26.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A hydraulic circuit having a control valve, a pump, a reservoir, a hydraulic work connection for a cylinder, a check valve that blocks a return flow of hydraulic fluid from the work connection to the control valve, and an overpressure safety device connected between the work connection and the check valve, characterized in that:
the overpressure safety device reduces an established overpressure by discharging hydraulic fluid between the check valve and the work connection, wherein the overpressure safety device comprises an overpressure valve and a throttle for throttling a flow of hydraulic fluid discharged through the overpressure safety device.

2. The hydraulic circuit of claim 1, further comprising:
a discharge channel through which the hydraulic fluid discharged through the overpressure safety device is fed back to the control valve, wherein the volume flow of the discharged hydraulic fluid is throttled by the control valve.

3. The hydraulic circuit of claim 1, wherein:
the hydraulic fluid discharged through the overpressure safety device is discharged through a discharge channel to the hydraulic tank), and the discharge channel includes a throttle for throttling a flow of hydraulic fluid to the hydraulic tank.

4. The hydraulic circuit of claim 1, wherein:
the overpressure safety device and the check valve are constructed in a single, integrated hydraulic component.

5. The hydraulic circuit of claim 1, wherein:
the work connection comprises a quick-connect coupler.

6. The hydraulic circuit of claim 1, wherein:
the check valve is controlled by a control pressure line.

7. The hydraulic circuit of claim 1, wherein:
the hydraulic circuit comprises first and second work connections for the cylinder, a first check valve being connected between the first work connection and the control valve, a second check valve being connected between the second work connection and the control valve, an overpressure safety device is connected between each the work connection and the corresponding check valve, each overpressure safety device discharging hydraulic fluid between the corresponding check valve and the corresponding work connection to reduce an overpressure, and each overpressure safety device comprises an overpressure valve and a throttle for throttling a flow of hydraulic fluid discharged through the corresponding overpressure safety device.

8. The hydraulic circuit of claim 7, wherein:
the first check valve is connected by a first work line to the control valve, the second check valve is connected by a second work line to the control valve, a first control pressure line connects the first work line to the second check valve, and a second control pressure line connects the second work line to the first check valve.
